(19) United States
(12) Patent Application Publication
(10) Pub. No.: US 2025/0383125 A1
(43) Pub. Date: Dec. 18, 2025

(54) HEATING SYSTEM AND METHOD FOR AN AIRCRAFT WATER CIRCUIT

(71) Applicant: AIRBUS ATLANTIC, ROCHEFORT (FR)

(72) Inventor: Daniel PERHERIN, SAINT NAZAIRE (FR)

(73) Assignee: AIRBUS ATLANTIC, ROCHEFORT (FR)

(21) Appl. No.: 18/713,735

(22) PCT Filed: Nov. 21, 2022
(86) PCT No.: PCT/EP2022/082564

§ 371 Date: Nov. 4, 2024

(30) Foreign Application Priority Data
Dec. 2, 2021 (FR) 2112826

(51) Int. Cl. F24H 15/156; B64D 45/00; B64D 47/00; F24H 15/136; F24H 15/225; F24H 15/242

(52) U.S. Cl. CPC F24H 15/156; B64D 45/00; B64D 47/00; F24H 15/136; F24H 15/225; F24H 15/242; B64D 2045/0085

(57) ABSTRACT

The invention relates to a heating system (S) for a water circuit (2) of an aircraft (1), the water circuit (2) defining. on the inside, an inside environment (M1) in which water can circulate and, on the outside, an outside environment (M2), the heating system (S) comprising at least one heating member (3), at least one inside temperature sensor (42), at least one humidity sensor (41) and at least one computer (5) that is configured to activate the heating member if the inside temperature (T1) is below a predetermined temperature threshold (TS), calculate a dew point (TR) based on the humidity parameter (H1) and the inside temperature (T1), and deactivate the heating member if the inside temperature (T1) is higher than the dew point (TR).

### TECHNICAL FIELD

This invention relates to the heating field for a water circuit in an aircraft, in particular a drinking water or wastewater circuit.

It is well known that an aircraft comprises several water circuits for delivering drinking water to water points or collecting wastewater at evacuation points. A water circuit then defines on the inside an inside environment in which water can circulate and on the outside an outside environment. In practice, the circulation of water in the inside environment is affected by the temperature of the inside environment. In particular, a water flow is likely to freeze in the water circuit if the temperature of the inside environment is below 0° C., which can block the water circuit and cause damage if pressurized.

To eliminate this disadvantage, it is known to position a heating member along the water circuit, for example an electric resistor, in order to heat the water circuit and melt any ice build-up likely to obstruct the water circuit. In a known way, the heating member is activated when the temperature of the inside environment is below a threshold temperature of 5° C. In practice, during the flight of an aircraft, the heating member is frequently activated even though there is no risk of icing. Similarly, before an aircraft is put into service, the heating member is systematically activated to eliminate any ice build-up that may have formed when the aircraft was stored.

The multiple activations of the heating member result in high energy costs. In order to make an aircraft more environmentally friendly, there is an interest in reducing this energy cost. An obvious solution would be to use a more efficient heating member, but this would have an impact on cost, overall dimension and weight.

In order to eliminate at least some of these disadvantages, a new system and a new method for heating an aircraft water circuit is proposed.

### SUMMARY

The invention relates to a heating system for a water circuit of an aircraft, the water circuit defining on the inside, an inside environment in which water can circulate and, on the outside, an outside environment, the heating system comprising:
at least one heating member positioned along the water circuit and configured to heat its inside environment,
at least one inside temperature sensor configured to measure an inside temperature in the inside environment, and
at least one calculator configured to activate the heating member if the inside temperature is below a predetermined temperature threshold.

The invention is remarkable in that the heating system comprises at least one humidity sensor configured to measure a humidity parameter in the inside environment and in that the calculator is further configured to:
calculate a dew point temperature from the humidity parameter and the inside temperature; and
inhibit the heating member if the inside temperature is above the dew point temperature.

The heating system allows the icing conditions of a water circuit to be determined dynamically by analyzing the conditions of the inside environment. In this way, the heating member can be activated only when necessary. In other words, unnecessary activation of the heating member is avoided, resulting in energy savings. In this way, heating can be avoided when the humidity parameter is low.

Preferably, the heating system comprising an inside pressure sensor configured to measure an inside pressure in the inside environment, the calculator is configured to determine the dew point temperature from a database which relates the humidity parameter, the inside temperature and the inside pressure. Advantageously, knowing the inside pressure allows the dew point temperature to be determined accurately.

Preferably, the calculator is configured to deactivate the heating member if the humidity parameter is less than a predetermined humidity threshold. So if the humidity is too low, no heating is carried out, regardless of the inside temperature. This is particularly relevant for a water circuit that does not need to be de-iced prior to the start-up of the aircraft, in particular a wastewater circuit.

Preferably, the heating system comprises at least one inside pressure sensor configured to measure an inside pressure in the inside environment, the calculator is configured to compare the inside pressure with a set inside pressure and send an alarm if the inside pressure is less than the set inside pressure. The heating system can therefore detect any leaks at an early stage.

Preferably, the water circuit comprising at least two ducts connected by a fitting, the inside temperature sensor is mounted on said fitting. Even more preferably, the inside pressure sensor is mounted on said fitting. Preferably, the humidity sensor is mounted in said fitting. This forms a fitting that can interact with the calculator in a practical way. This is particularly advantageous for an aircraft water circuit where the ducts are attached. The invention can therefore be applied to an existing aircraft.

The invention also relates to an assembly comprising an aircraft water circuit and a heating system as previously described.

The invention also relates to a method for heating an aircraft water circuit by means of a heating system as previously presented, the water circuit defining on the inside, an inside environment in which water can circulate and on the outside, an outside environment, the heating method comprising steps consisting in:
activating the heating member if the inside temperature is below a predetermined temperature threshold,
calculating a dew point temperature from the humidity parameter and the inside temperature; and
inhibiting the heating member if the inside temperature is higher than the dew point temperature.

The invention also relates to a calculator program comprising instructions for executing the steps of the heating method presented above when said program is executed by a calculator. The invention also relates to a recording medium for said calculator program.

### BRIEF DESCRIPTION OF THE DRAWINGS

The invention will be better understood on reading the following description, given by way of example, with reference to the following figures, given by way of non-limiting examples, in which identical references are given to similar objects.

FIG. 1 is a schematic representation of an aircraft comprising two water circuits.

FIG. 2 is a schematic representation of a water circuit with a heating system according to a first embodiment of the invention.

FIG. 3 is a schematic representation of a water circuit with a heating system according to a second embodiment of the invention.

FIG. 4 is a schematic representation of the steps involved in implementing a heating method according to the invention.

It should be noted that the figures set out the invention in detail in order to implement the invention, said figures of course being able to be used to better define the invention if necessary.

### DETAILED DESCRIPTION

With reference to [FIG. 1], an aircraft 1 comprising several water circuits 2, in particular a drinking water circuit and a wastewater circuit, is shown schematically. It goes without saying that the number of water circuits 2 could be different.

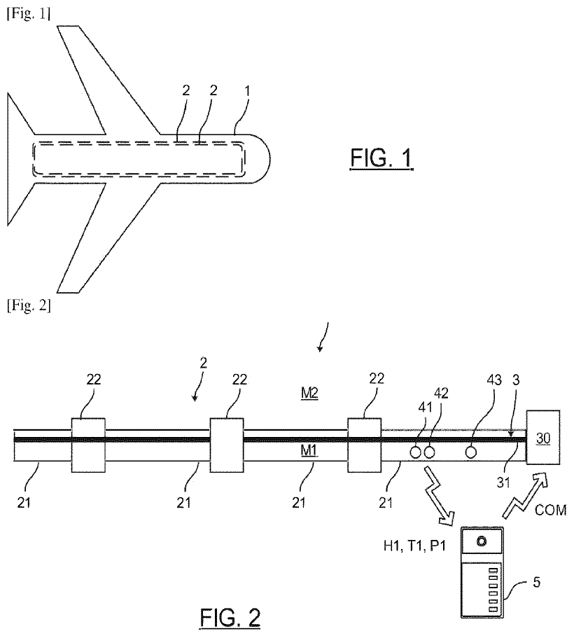

As illustrated in [FIG. 2], a water circuit 2 is shown comprising a number of ducts 21 which are connected by fittings 22. Preferably, the ducts 21 are attached and secured to the body of the aircraft 1. Preferably, the fittings 22 are movably mounted on the ducts 21 so as to connect them together.

The water circuit 2 then defines on the inside an inside environment M1 in which water can circulate and on the outside an outside environment M2. In other words, the outside environment M2 corresponds to the ambient environment and its pressure and temperature conditions may vary significantly depending on the conditions of use of the aircraft 1.

With reference to [FIG. 2], the aircraft 1 further comprises a heating system S for the water circuit 2 which comprises a heating member 3 positioned along the water circuit 2 and configured to heat its inside environment M1. As illustrated in [FIG. 2], the heating member 3 comprises a heating element 31 which extends along the water circuit 2, i.e. along ducts 21 and fittings 22, and a control device 30 configured to receive control instructions COM, in a wired or wireless manner, to activate/deactivate the heating element 31. Preferably, the control device 30 comprises an electronic communication card. In this example, the heating element 31 takes the form of an electrical conductor to generate heat by Joule effect. It goes without saying that other heating technologies (conduction, radiation, convection, etc.) may also be suitable. A heating element 31 is shown which is independent of the water circuit 2, but it goes without saying that the heating element 31 could be integrated into the water circuit 2. For example, the water circuit 2 could be covered, partially or entirely, by a conductive paint to allow a heating. In this example, the heating member 3 can be wired or wireless.

According to the invention, with reference to [FIG. 2], the heating system S comprises a humidity sensor 41 configured to measure a humidity parameter H1 in the inside environment M1 and an inside temperature sensor 42 configured to measure an inside temperature T1 in the inside environment M1.

A humidity sensor 41, known to the person skilled in the art, is used to measure the humidity in the inside environment M1, i.e. in the water circuit 2. This allows to detect the presence or absence of water. The hygrometric parameter H1 is advantageous because it allows to avoid heating by taking into account the level of humidity and the temperature in the water circuit 2, as will be shown later.

The humidity parameter H1 and the inside temperature T1 are used to accurately determine the inside environment M1. Optionally, in order to have in-depth knowledge of the inside environment M1, the heating system S comprises an inside pressure sensor 43, known to the person skilled in the art, configured to measure an inside pressure P1 in the inside environment M1. As the conditions in the inside environment M1 are known, it is advantageous to be able to detect any risk of icing conditions, as described below.

According to the invention, with reference to [FIG. 2], the heating system S also comprises a calculator 5 configured to calculate (Step E2 [FIG. 4]) a dew point temperature TR from the humidity parameter H1, the inside temperature T1 and the inside pressure P1. Dew can form on the inside wall of the water circuit depending on the conditions in the inside environment M1. In this example, the dew point temperature 30 TR is determined from a database, preferably in the form of charts, which are a function of the humidity parameter H1, the inside temperature T1 and the inside pressure P1. In this way, the dew point temperature TR can be calculated dynamically.

Optionally, the dew point temperature TR can be determined from a database determined for average inside pressure conditions P1. In this way, the dew point temperature TR can be determined solely from the humidity parameter H1 and the inside temperature T1.

In a known way, the calculator 5 is configured to activate (Step E1 [Figure 4]) the heating member 3 if the inside temperature T1 is below a predetermined threshold temperature TS, preferably between 2° C. and 8° C. In this example, the threshold temperature TS is 5° C. In practice, the calculator 5 is used to issue an activation command COM to activate the heating member 3.

According to the invention, the calculator 5 is configured to deactivate (Step E3 [FIG. 4]) the heating member 3 if the inside temperature T1 is higher than the dew point temperature TR. This allows to limit the energy consumption linked to the heating by avoiding an unnecessary heating when the icing conditions do not exist. For example, if the dew point temperature TR is −5° C., the water circuit 2 is not heated even if the inside temperature T1 is −2° C.

In this example, the calculator 5 is in the form of a calculator, but it goes without saying that it could be in various forms, in particular, in the form of a plurality of nearby or remote items of equipment.

Preferably, the calculator 5 is configured to deactivate the heating member 3 if the humidity parameter H1 is below a predetermined humidity threshold. In other words, if the humidity is too low, the water circuit 2 will not be heated even if the inside temperature T1 is very low. This provides significant energy savings.

Preferably, the calculator 5 is configured to compare the inside pressure P1 with a set inside pressure (defined by a water drive pump) and to issue an alarm if the inside pressure P1 is lower than the set inside pressure, in order to warn in the event of a leak. In this way, the heating system S can also be used to monitor the operation of the water circuit 2.

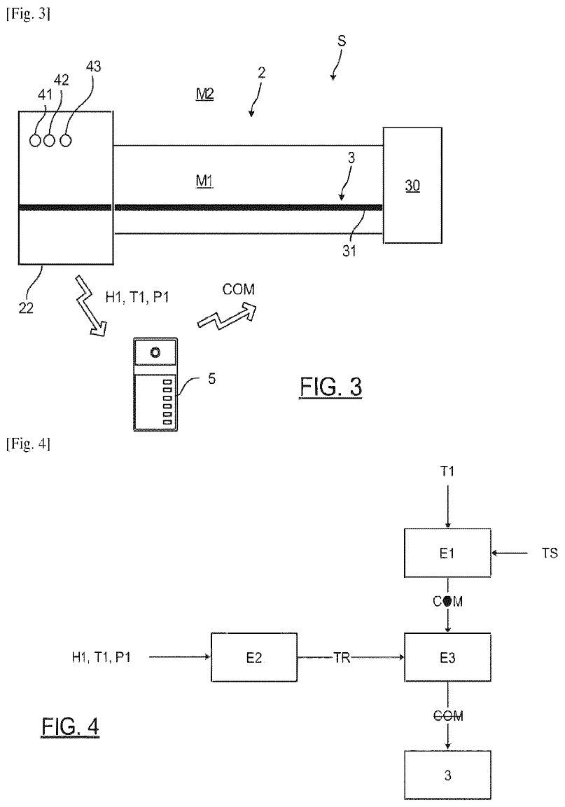

With reference to [FIG. 2], sensors 41-43 were shown mounted in a fitting manner, on the water circuit 2, in particular, on a duct 21 of said water circuit 2 connected to the inside environment M1. According to one aspect of the invention, with reference to [FIG. 3], the humidity sensor 41 and the inside temperature sensor 42 are mounted in the fitting 22. In this way, the fitting acts as a measuring station, which is advantageous. The inside pressure sensor 43 can also be mounted in the fitting 22. Preferably, the sensors 41-43 are integrated into said fitting 22 so as to allow a heating system S to be conveniently installed in an existing aircraft 1. The advantages of the invention can be realised by simply changing a fitting 22. Preferably, the fitting 22 forms an independent measurement station which can communicate with the calculator 5. Preferably, each fitting 22 is autonomous and comprises a power source (battery, generator, electrical connector to an electrical network, etc.) and a member for communicating with the calculator 5 (wired or wireless communication card). Preferably, several fittings 22 can be positioned in the water circuit 2 in order to obtain local measurements and thus produce heating adapted to different local portions of the water circuit 2.

The inside temperature sensor 42 can be mounted in the outside environment M2 in contact with the wall of a duct 21 or the fitting 22 so as to measure the inside temperature T1 indirectly.

The invention also relates to a method for heating an aircraft water circuit 2 by means of a heating system S as previously presented, the heating method comprising steps consisting of:
activating E1 the heating member 3 if the inside temperature T1 is below a predetermined temperature threshold TS,
calculating E2 a dew point temperature TR from the humidity parameter H1 and the inside temperature T1; and
inhibiting E3 the heating member 3 if the inside temperature T1 is higher than the dew point temperature TR.

As illustrated in [Figure 4], if the inside temperature T1 is below a predetermined temperature threshold TS, the calculator 5 issues an activation command COM which is inhibited if the inside temperature T1 is above the dew point temperature TR.

The invention has been presented in general terms for a heating system S heating a water circuit 2, but it goes without saying that the heating system S can be implemented independently on different portions of a water circuit in order to provide customized heating according to the local measurements made by the sensors.

Advantageously, each water circuit 2 (or portion of water circuit 2) is heated by comparing the inside temperature T1 with the dew point temperature TR of the water circuit 2 (or portion of water circuit 2). In this way, a drinking water circuit and a wastewater circuit can be heated differently, in particular because the flow rate is lower in a wastewater circuit and the humidity is lower.

In the prior art, a water circuit 2 was systematically heated before an aircraft was started up. Thanks to the invention, a water circuit 2 is only heated when it is needed, which provides significant savings.

1-8. (canceled)

9. A heating system for a water circuit of an aircraft, the water circuit defining on the inside, an inside environment in which water can circulate and, on the outside, an outside environment, the heating system comprising:
at least one heating member positioned along the water circuit and configured to heat its inside environment,
at least one inside temperature sensor configured to measure an inside temperature in the inside environment,
at least one calculator configured to activate the heating member if the inside temperature is below a predetermined temperature threshold,
the system comprising at least one humidity sensor configured to measure a humidity parameter in the inside environment,
the calculator being further configured to:
calculate a dew point temperature from the humidity parameter and the inside temperature; and
inhibit the heating member if the inside temperature is higher than the dew point temperature.

10. The heating system according to claim 9, wherein, the heating system comprising an inside pressure sensor configured to measure an inside pressure in the inside environment, the calculator is configured to determine the dew point temperature from a database which relates the humidity parameter, the inside temperature and the inside pressure.

11. The heating system according to claim 9, wherein the calculator is configured to deactivate the heating member if the humidity parameter is less than a predetermined humidity threshold.

12. The heating system according to claim 9, comprising at least one inside pressure sensor configured to measure an inside pressure in the inside environment, the calculator is configured to:
compare the inside pressure with a set inside pressure and
send an alarm if the inside pressure is lower than the set inside pressure.

13. The heating system according to claim 9, wherein, the water circuit comprising at least two ducts connected by a fitting, the inside temperature sensor is mounted on said fitting.

14. The heating system according to claim 13 wherein the inside pressure sensor is mounted on said fitting.

15. An assembly comprising a water circuit of an aircraft and a heating system according to claim 9.

16. A method for heating an aircraft water circuit by means of the heating system according to claim 9, the water circuit defining on the inside, an inside environment in which water can circulate and on the outside, an outside environment, the heating method comprising steps consisting in:
activating the heating member if the inside temperature is below a predetermined temperature threshold,
calculating a dew point temperature from the humidity parameter and the inside temperature; and
inhibiting the heating member if the inside temperature is higher than the dew point temperature.
